(19) United States
(12) Patent Application Publication
(10) Pub. No.: US 2023/0358376 A1
(43) Pub. Date: Nov. 9, 2023

(54) LED LIGHT STRIP BENDABLE IN ANY DIRECTION

(71) Applicants: HUIZHOU CLEAR LIGHTING CO., LTD., Huizhou (CN); SHENZHEN CLEAR LIGHTING CO., LTD., Shenzhen (CN)

(72) Inventors: Changgui LIU, Shenzhen (CN); Chenghuo SHANG, Shenzhen (CN); Minfei HUANG, Shenzhen (CN)

(21) Appl. No.: 17/947,162

(22) Filed: Sep. 18, 2022

(30) Foreign Application Priority Data
May 5, 2022 (CN) 202221059547.5

(51) Int. Cl. F21V 23/00; F21S 4/24

(52) U.S. Cl. CPC F21S 4/24; F21V 23/002; F21Y 2115/10

(57) ABSTRACT

The invention discloses an LED light strip bendable in any direction, comprising: a strip core which is made of soft material, and a stretchable main wire embedded on each side of said strip core, and a plurality of LEDs arranged at intervals along the length direction of said strip core in the middle; said LEDs being connected between two said stretchable main wires of said strip core individually or in series through connecting wires; an insulating layer encapsulating said strip core; wherein each said stretchable main wire includes at least two conductive stranded wire bundles combined with each other, and each said conductive stranded wire bundle includes at least one metal conductive wire, and said conductive stranded wire bundle is wavy along the length direction thereof. By implementing the embodiments of the present invention, the multi-angle and multi-directional bending of the light strip can be realized.

### RELATED APPLICATIONS

This application claims priority to Chinese Application Number 202221059547.5, filed on May 5th, 2022, entitled AN LED LIGHT STRIP BENDABLE IN MULTIPLE DIRECTIONS, all of the disclosures of which are incorporated herein by reference in their entirety.

### FIELD OF THE INVENTION

Embodiments of the present disclosure relate to LED lighting field, and more particularly to an LED light strip bendable in any direction.

### DISCUSSION OF THE RELATED ART

FIGS. 1 to 4 show an existing flexible light strip. Wherein, FIG. 1 shows a strip core 1′ made of soft elastic plastic or silicone. At least two main wires 20′ and 21′ of the same length as the light strip are preset in the strip core 1′. The two main wires are on the same horizontal line and parallel to the surface of the light strip, and a strip core groove 8′ in the middle with the same length as the strip core is reserved. FIG. 2 shows a light string 3′ which includes light sources 5′, electronic components 6′ and connecting wires 7′. The light string 3′ will be embedded in the strip core groove 8′ shown in FIG. 2, and then the heads and the tails of the light string units are connected in parallel to the main wires 20′ and 21′ of the strip core 1′. As shown in FIG. 3, usually a light strip is composed of multiple light string units. On the basis of FIG. 3, a layer of soft elastic plastic or silicone 4′ encapsulates to form a complete light strip as shown in FIG. 4.

However, the existing light strip can only be top bent (as shown in FIG. 5). At this time, the bending force of the two main wires is equal. If it is side bent, one of the main wires 20′ will be compressed, and the other main wire 21′ will be elongated. Although the elastic plastic or silicone can be stretched or compressed, the light strip itself cannot meet the shortening and elongating force of the two main wires, when the bending force is large enough, the main wires will be at risk of being broken. Meanwhile, in the prior art, the light string is generally arranged on a long PCB, when the flexible light strip is bent, especially when the bending direction is not in the direction of the wide surface of the long PCB, the long PCB also has the risk of broken.

### SUMMARY

The technical problem to be solved by the present invention is to provide an LED light strip bendable in any direction, so that the multi-direction and multi-angle bending of the light strip can be realized, and the light strip can be used in any direction, and the wire inside the light strip has high strength which is not easy to be damaged.

To solve above-mentioned technical problem, the present invention provides an LED light strip bendable in any direction, comprises:
a strip core which is made of soft material, and a stretchable main wire embedded on each side of said strip core, and a plurality of LEDs arranged at intervals along the length direction of said strip core in the middle;
said LEDs being connected between two said stretchable main wires of said strip core individually or in series through connecting wires;
an insulating layer encapsulating said strip core;
wherein each said stretchable main wire includes at least two conductive stranded wire bundles combined with each other, and each said conductive stranded wire bundle includes at least one metal conductive wire, and said conductive stranded wire bundle is wavy along the length direction thereof.

Advantageously, each said stretchable main wire includes at least two cross-combined conductive stranded wire bundles, or

each said stretchable main wire includes an inner core and at least two conductive stranded wire bundles wound outside said inner core in a cross-combination; said inner core is a straight metal wire inner core, or a straight non-metallic inner core, or a wavy non-metallic inner core, or an inner core formed by winding a plurality of metal conductive wires, or an inner core formed by winding multiple metallic conductive wires and non-metallic wires.

Advantageously, each said conductive stranded wire bundle includes a plurality of metal conductive wires arranged side by side, or
said conductive stranded wire bundle includes metal conductive wires and non-metallic wires arranged side by side and at intervals;
wherein each of said metal conductive wires and non-metallic wires is wavy along the length direction thereof.

Advantageously, a plurality of PCBs are arranged at intervals in said strip core, each said PCB is soldered with an SMD LED and/or SMD electronic components, and all said SMD LEDs and/or SMD electronic components are electrically connected; each said PCB is connected in series between two said stretchable main wires through connecting wires separately; or a plurality of said PCBs are connected in series with each other by using said connecting wires, and then are connected in series between the two stretchable main wires through said connecting wires which are bent metal wires.

Advantageously, at least one LED light string is arranged in said strip core, and each LED light string includes a plurality of LEDs connected in series through said connecting wires, and both ends of each said LED light string are connected between two said stretchable main wires through said connecting wires which are bent metal wires.

Advantageously, a plurality of FPCBs are arranged at intervals in said strip core, each said FPCB is soldered with an SMD LED and/or SMD electronic components, and all said SMD LEDs and/or SMD electronic components are electrically connected; both ends of each said LED light string are connected between two said stretchable main wires through said connecting wires which are bent metal wires.

Advantageously, at least part of said connecting wires is a wavy curve connecting wire or a coil spring connecting wire.

Advantageously, said connecting wires and metal conductive wires are made of iron, copper, aluminum, copper or alloys of the above-mentioned materials; and said strip core, said insulating wrapping layer, said straight non-metallic inner core, said wavy non-metallic inner core and said non-metallic wire are all made of soft plastic or silicon; and the cross-section of said stretchable main wire is circular, oval, square or asymmetrical.

Advantageously, said strip core and said insulating wrapping layer are added with colored pigments.

Performing the present invention will bring out the following beneficial effects:

In the embodiment of the present invention, a stretchable main wire is embedded on both sides of the strip core respectively, and the stretchable main wire includes at least two cross-combined conductive stranded wire bundles. In addition, the connecting wire between the PCB, light string or FPCB where the LED is located and the main wire is in the form of a curve. Since both the main wires and the connecting wires have properties of being compressible or elongated, stretchable and bendable, the bending resistance of the LED light strip can be improved, so that it can be bent at multiple angles and in multiple directions. And it can reduce the problem of product failure when the PCB or FPCB is twisted or bent, and improves the application range and convenience of use of the product.

At the same time, in the present invention, the main wire is cross-combined by multi-strand metal conductive wires, which has characteristics of being not easy to loosen, break, fall off, etc., and the conductive stranded wire bundles in the main wires are all wavy along the length direction thereof, which can further Improve the tensile strength of the LED light strip, thereby improving the service life of the LED light strip.

### BRIEF DESCRIPTION OF THE DRAWINGS

In order to more clearly illustrate the embodiments of the present invention or the technical solutions in the prior art, the drawings used in the embodiments or the description of the prior art will be briefly described below. Obviously, the drawings in the following description are only certain embodiments of the present invention, and other drawings can be obtained from those skilled in the art without any creative work.

FIG. 1 is a schematic diagram of the strip core structure of an existing flexible light strip.

FIG. 2 is a schematic diagram showing the structure of the light string of an existing flexible light strip.

FIG. 3 is a schematic diagram showing the principle of the structure shown in FIG. 1 and FIG. 2 after being assembled.

FIG. 4 is a schematic diagram of the structure after being encapsulated by a layer of soft elastic plastic or silicone on the basis of FIG. 3.

FIG. 5 is a schematic diagram of the structure, shown in FIG. 4, which is top bent.

FIG. 6 is a schematic structural diagram of an LED light strip bendable in any direction according to the first embodiment of the present invention.

FIG. 7 is a schematic structural diagram of the electrical connection between the PCB and the stretchable main wire shown in FIG. 6.

FIG. 8 is a schematic structural diagram of the stretchable main wire shown in FIG. 6.

FIG. 9 is a schematic diagram of the stretchable main wire shown in FIG. 8 in compressed state.

FIG. 10 is a schematic diagram of the stretchable main wire shown in FIG. 8 in stretched state.

FIG. 11 is a schematic structural diagram of another stretchable main wire according to the present invention.

FIG. 12 is a schematic structural diagram of another stretchable main wire according to the present invention.

FIG. 13 is a schematic structural diagram of a conductive wire bundle in the stretchable main wire according to the present invention.

FIG. 14 is a schematic structural diagram of another conductive wire bundle in the stretchable main wire according to the present invention.

FIG. 15 is a schematic structural diagram of a connecting wire according to the present invention.

FIG. 16 is a schematic structural diagram of another connecting wire according to the present invention.

FIG. 17 is a schematic structural diagram of an LED light strip bendable in any direction according to the second embodiment of the present invention..

FIG. 18 is a schematic structural diagram of the electrical connection between the PCB and the stretchable main wire shown in FIG. 17.

FIG. 19 is a schematic structural diagram of an LED light strip bendable in any direction according to the third embodiment of the present invention..

FIG. 20 is a schematic structural diagram of the electrical connection between the PCB and the stretchable main wire shown in FIG. 19.

FIG. 21 shows a schematic diagram of multi-direction and multi-angle bending according to various embodiments of the present invention.

### DETAILED DESCRIPTION OF THE EMBODIMENTS

The technical solutions in the embodiments of the present invention are clearly and completely described below with reference to the accompanying drawings in the embodiments of the present invention. Apparently, the described embodiments are merely a part of but not all embodiments of the present invention. All other embodiments obtained by a person of ordinary skilled in the art based on the embodiments of the present invention without creative efforts shall fall within the protection scope of the present invention.

As shown in FIGS. 6-10, it is the first embodiment of an LED light strip bendable in any direction according to the present invention.

In this embodiment, the LED light strip bendable in any direction includes:

a strip core 1 which is made of soft material, and a stretchable main wire 2 embedded on each side of the strip core, and a plurality of LEDs 31 arranged at intervals along the length direction of the strip core in the middle. The cross-section of the strip core 1 is roughly concave, but it could be understood that it is not limited to this shape in other embodiments. There is a strip core groove 8 arranged along the direction of the light strip in the middle, and at least two stretchable main wires are arranged in the strip core on both sides of the strip core groove 8. In other embodiments, the structure of the above-mentioned strip core groove 8 may not be adopted, and the stretchable main wire may be directly arranged on both sides of the strip core wire 1.

In this embodiment, a plurality of PCBs 3 are arranged in the strip core 1 at intervals, and each PCB is soldered with a SMD LED 31 and/or SMD electronic components, and all SMD LEDs and SMD electronic components are electrically connected.

In this embodiment, each PCB 3 is connected in series between the two stretchable main wires 2 through connecting wires 5 separately; or a plurality of PCBs 3 are connected in series with each other by using connecting wires 5, and then are connected in series between the two stretchable main wires 2 by using connecting wires 5. The connecting wires 5 are bent metal wires.

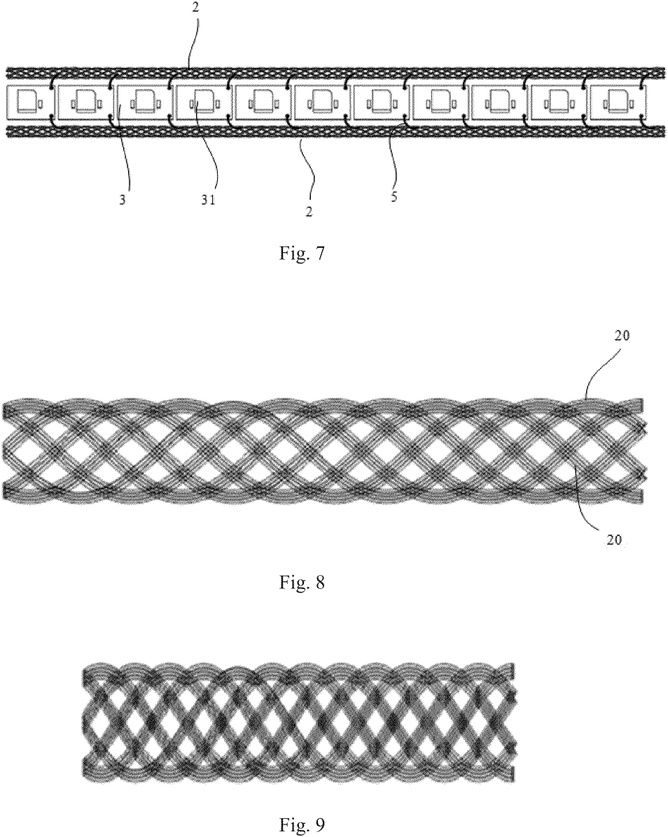

More specifically, each PCB 3 may at least include a light board body, an LED 31, electronic components and connecting wires (not shown) for connecting the LED 31 and the electronic components, wherein, the heads and tails of at least part of the PCBs 3 which are connected in series are connected between the two stretchable main wires 2 of the strip core of the LED light strip through the connecting wires 5. In this embodiment, the structure of the PCB 3 and the connection between it and the stretchable main wires can be referred to FIG. 7. The light strip formed by a plurality of PCBs 3 has the same length as the strip core. It could be understood that the length of the connecting wire 5 is larger than the distance between the two components it connects, thereby improving the bending performance. Specifically, in other embodiments, at least part of the adjacent PCBs are connected by the connecting wires, and the length of the connecting wire is larger than the distance between the adjacent PCBs;

An insulating layer 4 encapsulates the strip core 1.

In this embodiment, each stretchable main wire 2 includes at least two conductive stranded wire bundles 20 combined mutually. It could be understood that the combination here can be various ways such as interweaving, intertwining and the like.

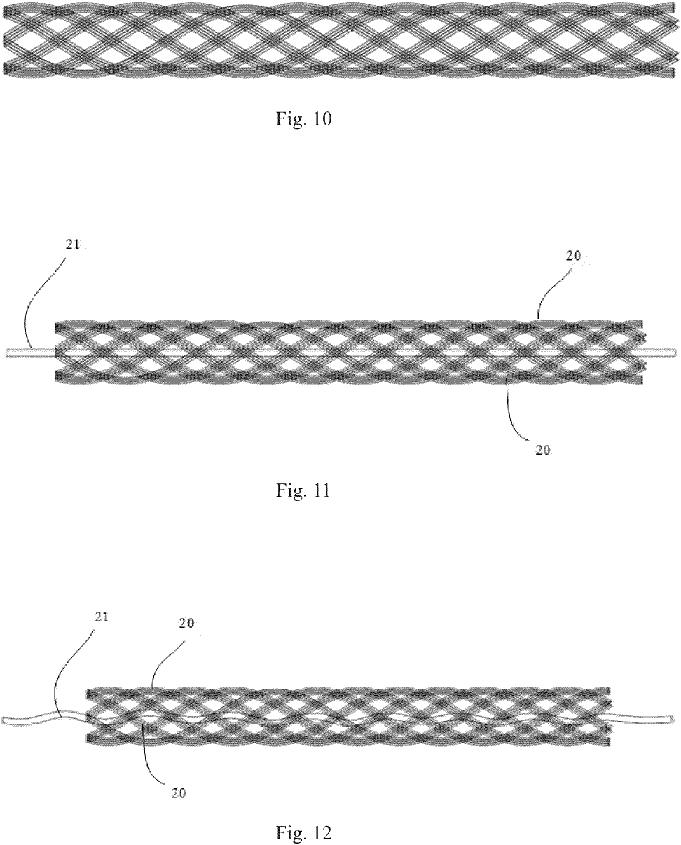

The main difference between this embodiment and the prior art is that each stretchable main wire 2 in this embodiment includes a stretchable structure. Specifically, as shown in FIG. 8, in this embodiment, each stretchable main wire 2 includes at least two cross-combined conductive stranded wire bundles 20. In this embodiment, each stranded conductive wire bundle 20 includes at least one metal conductive wire, and the stranded conductive wire bundles are all wavy along the length direction thereof. Based on the cross-combined structure, when the stretchable main wire 2 is stretched or compressed by force, it can be lengthened or shortened like a spring, and it can also be automatically return to its original state without any force. Please refer to FIG. 9, a schematic view of the stretchable main wire in compressed state is shown, and FIG. 10 shows a schematic view of the stretchable main wire in stretched state. The shape of the conductive stranded wire bundle 20 can be flat, round, square or any other shape. Similarly, the conductive stranded wire bundle 20 has the characteristics that it is not easy to loosen, break, fall off, etc., and can be bent into any shape such as semi-arc, wave, square wave, etc. Thus, the cross-section of the stretchable main wire may form a circular, oval, square or asymmetrical shape. Through this arrangement, the conductive stranded wire bundle has obtained the characteristics of being not easy to loosen, break, fall off, etc., and its shape has an expansion and contraction function like a spring within a certain range under the action of external force, and is easy to stretch or compress.

In this embodiment, the strip core 1 and the insulating wrapping layer 4 can be made of soft plastic or silicone, for example, PVC, silicone, PU or other soft plastic. The stretchable main wire 2 can be made of copper, aluminum, steel or alloys of the above materials.

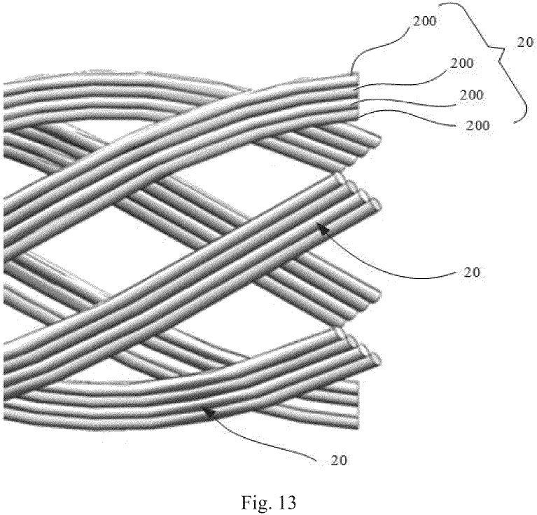

Referring to FIG. 11 and FIG. 12, there are shown the structural schematic diagrams of another two types of stretchable main wires according to the present invention respectively.

In the two examples, each stretchable main wire 2 includes an inner core 21 and at least two conductive stranded wire bundles 20 that are crossed or parallel combined and wound outside the inner core 21. Specifically, the inner core is a straight inner core, as shown in FIG. 11, wherein the inner core 21 may be a straight metal wire inner core, a straight non-metallic inner core, and the inner core may also be a wave-shaped inner core, as shown in FIG. 12, the inner core 21 may be a wave-shaped non-metallic inner core. In other examples, the inner core 21 may also be formed by winding a plurality of stranded wires, for example, by winding a plurality of metal conductive wires, or a plurality of metal conductive wires together with non-metallic wires.

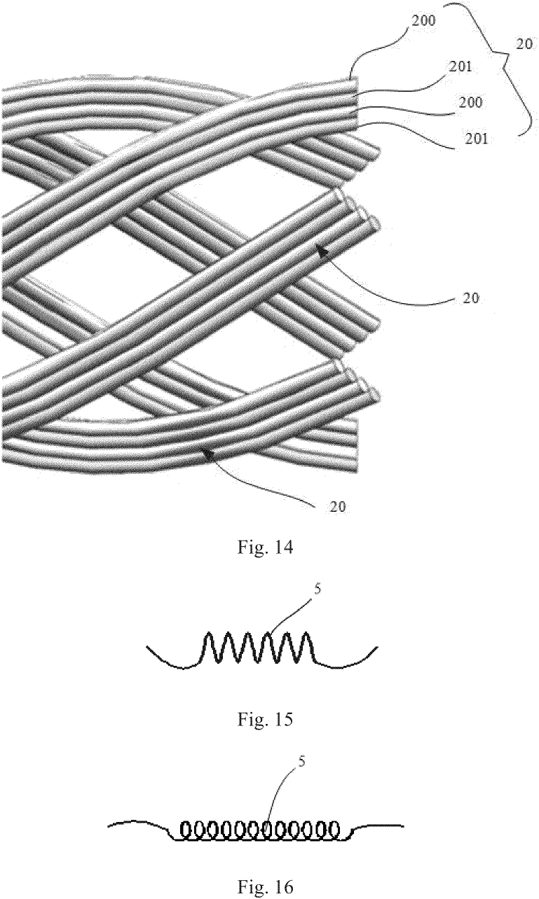

As shown in FIG. 13 and FIG. 14, there are shown the structural schematic diagrams of two types of conductive stranded wire bundles in the stretchable main wire according to the present invention. In FIG. 13, each conductive stranded wire bundle 20 includes a plurality of metal conductive wires 200 arranged side by side. In the figure, each stranded conductive wire bundle 20 includes four metal conductive wires 200. It could be understood that the above numbers are for example only. In FIG. 14, the stranded conductive wire bundle 20 includes metal conductive wires 200 and non-metallic wires 201 arranged side by side and at intervals. Each stranded conductive wire bundle 20 in the figure includes two metal conductive wires 200 and two non-metallic wires 201, arranged alternately at intervals, and it could be understood that the above numbers are for example only. In the two figures, each metal conductive wire 200 and non-metallic wire 201 are both wavy along the length direction thereof.

As shown in FIG. 15 and FIG. 16, the schematic diagrams of the structures of two types of the connecting wires according to the present invention are shown. In the first embodiment, the connecting wire 5 has a curved shape, and specifically, a wavy curve connecting wire or a coil spring connecting wire can be used. As shown in FIG. 15, a wavy curve connecting wire is shown. The effect offered by such arrangement is that through changing the shape of the connecting wire 5, when the light strip is bent in different directions, the light string can better adapt to the bending. Since the connecting wires can be stretched or shortened according to the bending of the light strip, via a large enough displacement between their connections, when the LED light strip of this embodiment is bent at multiple angles or in multiple directions, the internal structure of the light strip will not be damaged. FIG. 16 shows a structure of a coil spring connecting wire. It could be understood that, in other examples, other curved structures can also be used.

It could be understood that the above-mentioned connecting wires and metal conductive wires are made of iron, copper, aluminum, copper or alloys of the above-mentioned materials. The strip core, the insulating wrapping layer, the straight non-metallic inner core, the wavy non-metallic inner core and the non-metallic wire are all made of soft plastic or silicon. The cross-section of the stretchable main wire is circular, oval, square or asymmetrical.

In other examples, the strip core and the insulating wrap layer may be transparent or foggy, and may be added color pigments, such as red, green, blue, or any other color pigments, thereby adapting the LED strip to different applications.

Similarly, the direction in which the PCB 3 is placed can be adjusted, and it can be set horizontally, vertically, or at any other position or angle, and can still achieve the same application function.

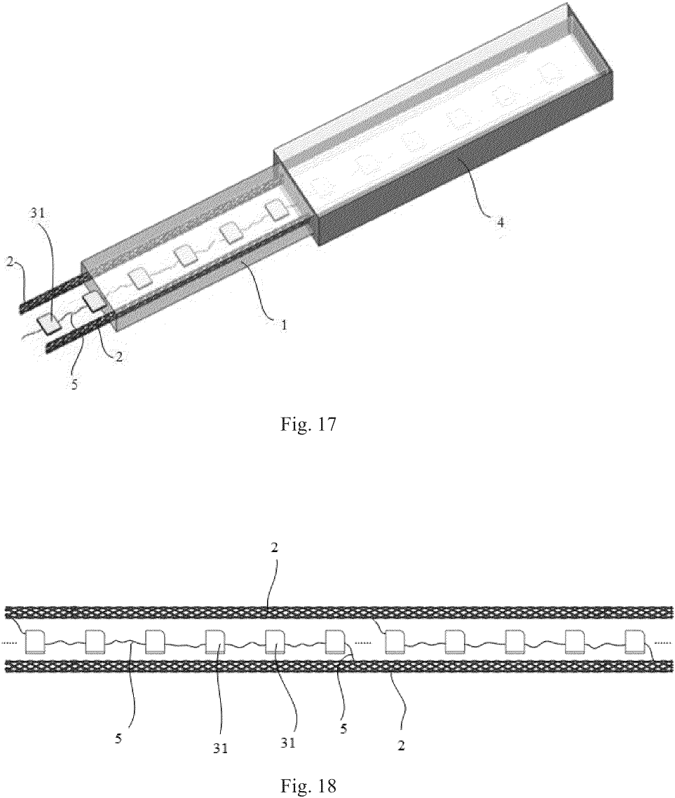

As shown in FIG. 17 and FIG. 18, it is the second embodiment of an LED light strip bendable in any direction according to the present invention.

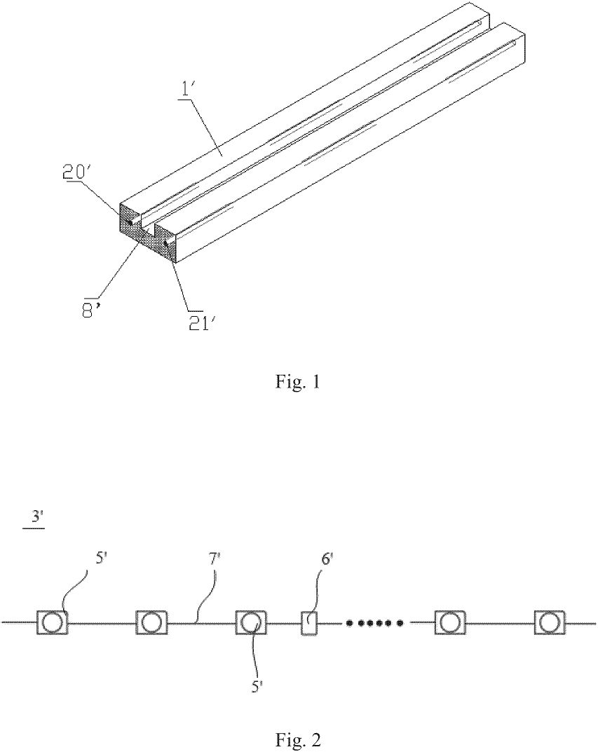

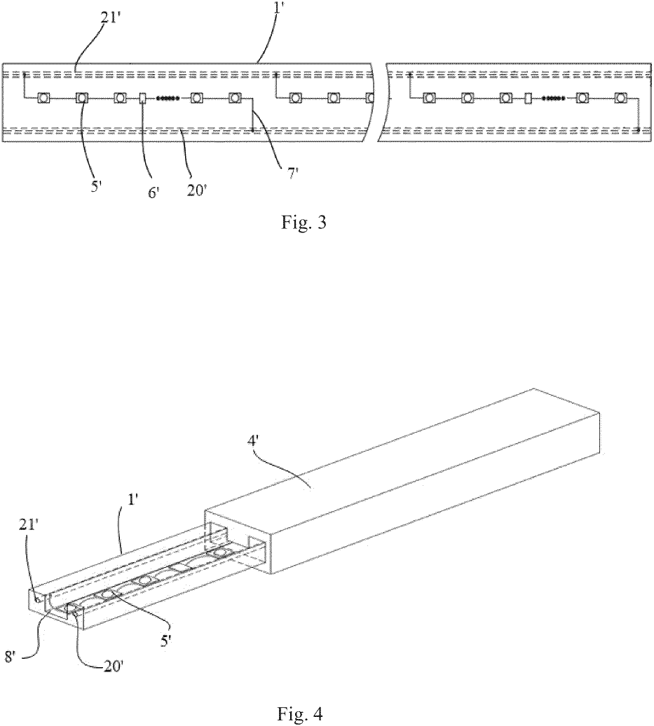

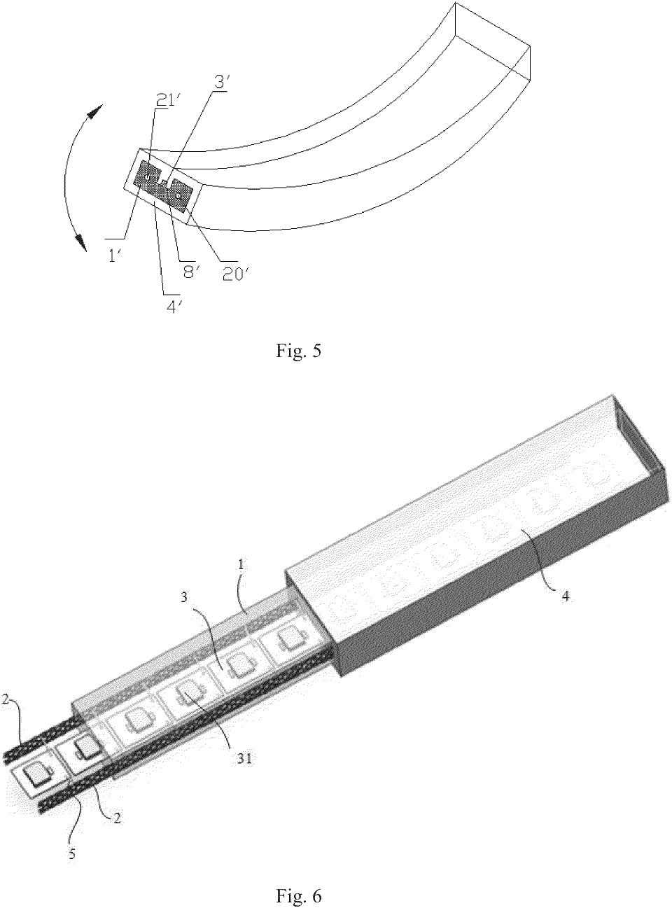

In this embodiment, the difference in structure from shown in FIG. 1 lies in the arrangement of the LEDs 31. In the second embodiment, at least one LED light string is arranged in the strip core 1, and each LED light string includes a plurality of LEDs 31 connected in series through the connecting wires 5, and each LED light string is connected in series on the two stretchable main wires 2 through the connecting wires 5 which are bent metal wires.

For other structures involved in the second embodiment, especially the structures of the stretchable main wires 2 and the connecting wires 5, reference may be made to and combined with the foregoing descriptions of FIGS. 6 to 16. Specifically, the stretchable main wires 2 may adopt the structures shown in FIG. 8 and FIGS. 11 to 14, and the connecting wires 5 can adopt the structure shown in FIG. 15 and FIG. 16.

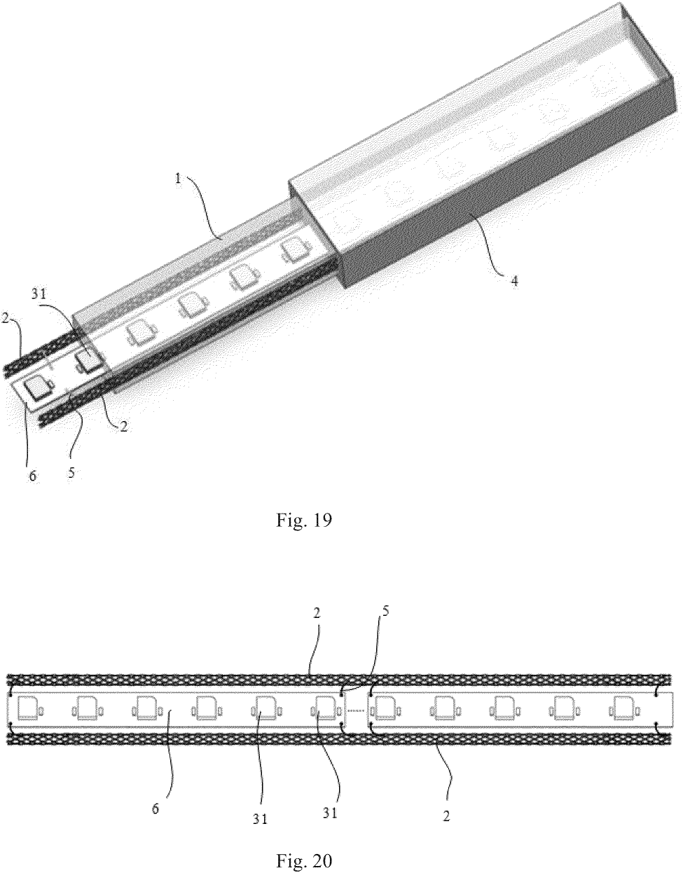

As shown in FIG. 19 and FIG. 20, it is the third embodiment of an LED light strip bendable in any direction according to the present invention.

In this embodiment, the difference in structure from shown in FIG. 1 lies in the arrangement of the LEDs 31. In the third embodiment, at least one FPCB 6 is arranged in the strip core 1, and each FPCB 6 is soldered with a plurality of SMD LEDs 31 and/or SMD electronic components. The SMD LEDs and/or SMD electronic components are electrically connected;

and each FPCB 6 is connected in series on the two stretchable main wires 2 through the connecting wires 5 which are bent metal wires.

For other structures involved in the third embodiment, especially the structures of the stretchable main wires 2 and the connecting wires 5, reference may be made to and combined with the foregoing descriptions of FIGS. 6 to 16. Specifically, the stretchable main wires 2 may adopt the structures shown in FIG. 8 and FIGS. 11 to 14, and the connecting wires 5 can adopt the structure shown in FIG. 15 and FIG. 16.

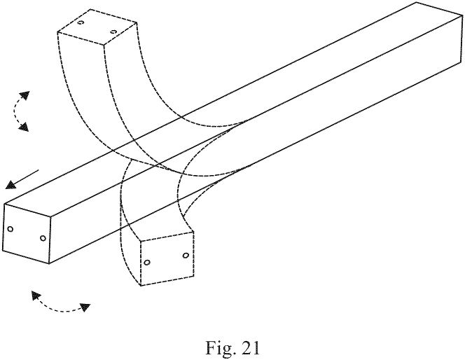

As shown in FIG. 21, a schematic diagram of multi-directional and multi-angle bending of the present invention is shown. It can be more clearly understood that the present invention can achieve the effect of bending at multiple angles and in any directions. The figure shows the bending effects in two different directions (shown by dotted lines). It could be understood that other angles and directions of bending can also be achieved without damaging the internal circuit structure. The above-mentioned first to third embodiment can achieve the effect shown in FIG. 21.

Performing the present invention will bring out the following beneficial effects:

In the embodiment of the present invention, a stretchable main wire is embedded on both sides of the strip core respectively, and the stretchable main wire includes at least two cross-combined conductive stranded wire bundles. In addition, the connecting wire between the PCB, light string or FPCB where the LED is located and the main wire is in the form of a curve. Since both the main wires and the connecting wires have properties of being compressible or elongated, stretchable and bendable, the bending resistance of the LED light strip can be improved, so that it can be bent at multiple angles and in multiple directions. And it can reduce the problem of product failure when the PCB or FPCB is twisted or bent, and improves the application range and convenience of use of the product.

At the same time, in the present invention, the main wire is cross-combined by multi-strand metal conductive wires, which has characteristics of being not easy to loosen, break, fall off, etc., and the conductive stranded wire bundles in the main wires are all wavy along the length direction thereof, which can further Improve the tensile strength of the LED light strip, thereby improving the service life of the LED light strip.

It is believed that the present embodiments and their advantages will be understood from the foregoing description, and it will be apparent that various changes may be made thereto without departing from the spirit and scope of the invention or sacrificing all of its material advantages, the examples hereinbefore described merely being preferred or exemplary embodiments of the invention.

What is claimed is:

1. An LED light strip bendable in any direction comprising:
a strip core which is made of soft material, and a stretchable main wire embedded on each side of said strip core, and a plurality of LEDs arranged at intervals along the length direction of said strip core in the middle;
said LEDs being connected between two said stretchable main wires of said strip core individually or in series through connecting wires;
an insulating layer encapsulating said strip core;
wherein each said stretchable main wire includes at least two conductive stranded wire bundles combined with each other, and each said conductive stranded wire bundle includes at least one metal conductive wire, and said conductive stranded wire bundle is wavy along the length direction thereof such that said conductive stranded wire bundle forms a first spring-like structure, and each said metal conductive wire of said conductive stranded wire bundle includes a second spring-like structure, rendering said conductive stranded wire bundle stretchable/compressible to selectively change a length thereof.

2. The LED light strip bendable in any direction as claimed in claim 1, wherein each said stretchable main wire includes at least two cross-combined conductive stranded wire bundles, or
each said stretchable main wire includes an inner core and at least two conductive stranded wire bundles wound outside said inner core in a cross-combination; said inner core is a straight metal wire inner core, or a straight non-metallic inner core, or a wavy non-metallic inner core, or an inner core formed by winding a plurality of metal conductive wires, or an inner core formed by winding multiple metallic conductive wires and non-metallic wires.

3. The LED light strip bendable in any direction as claimed in claim 2, wherein each said conductive stranded wire bundle includes a plurality of metal conductive wires arranged side by side, or
said conductive stranded wire bundle includes metal conductive wires and non-metallic wires arranged side by side and at intervals;
wherein each of said metal conductive wires and non-metallic wires is wavy along the length direction thereof.

4. The LED light strip bendable in any direction as claimed in claim 3, wherein a plurality of PCBs are arranged at intervals in said strip core, each said PCB is soldered with an SMD LED and/or SMD electronic components, and all said SMD LEDs and/or SMD electronic components are electrically connected;
each said PCB is connected in series between two said stretchable main wires through connecting wires separately; or a plurality of said PCBs are connected in series with each other by using said connecting wires, and then are connected in series between the two stretchable main wires through said connecting wires which are bent metal wires.

5. The LED light strip bendable in any direction as claimed in claim 3, wherein at least one LED light string is arranged in said strip core, and the at least one LED light string includes the plurality of LEDs connected in series through said connecting wires, and each of the at least one LED light string has two ends that are connected between two said stretchable main wires through said connecting wires which are bent metal wires.

6. The LED light strip bendable in any direction as claimed in claim 3, wherein a plurality of FPCBs are arranged at intervals in said strip core, the plurality of LEDs comprising SMD LEDs, each said FPCB is soldered with multiple ones of the SMD LEDs and/or SMD electronic components, and all said SMD LEDs and/or SMD electronic components are electrically connected;
each said FPCB has two ends that are connected between two said stretchable main wires through said connecting wires which are bent metal wires.

7. The LED light strip bendable in any direction as claimed in claim 4, wherein at least part of said connecting wires is a wavy curve connecting wire or a coil spring connecting wire.

8. The LED light strip bendable in any direction as claimed in claim 5, wherein at least part of said connecting wires is a wavy curve connecting wire or a coil spring connecting wire.

9. The LED light strip bendable in any direction as claimed in claim 6, wherein at least part of said connecting wires is a wavy curve connecting wire or a coil spring connecting wire.

10. The LED light strip bendable in any direction as claimed in claim 7, wherein said connecting wires and metal conductive wires are made of iron, copper, aluminum, copper or alloys of the above-mentioned materials; and said strip core, said insulating wrapping layer, said straight non-metallic inner core, said wavy non-metallic inner core and said non-metallic wire are all made of soft plastic or silicon; and the cross-section of said stretchable main wire is circular, oval, square or asymmetrical.

11. The LED light strip bendable in any direction as claimed in claim 10, wherein said strip core and said insulating wrapping layer are added with colored pigments.
